(19) United States
(12) Patent Application Publication
(10) Pub. No.: US 2016/0088131 A1
(43) Pub. Date: Mar. 24, 2016

(54) HOUSING AND ELECTRONIC DEVICE INCLUDING THE SAME

(71) Applicant: Sony Corporation, Tokyo (JP)

(72) Inventor: Chi-Yuk CHIU, Kowloon (HK)

(21) Appl. No.: 14/695,647

(22) Filed: Apr. 24, 2015

(30) Foreign Application Priority Data
Sep. 24, 2014 (CN) 201410493414.2

(51) Int. Cl. H04M 1/02

(52) U.S. Cl. CPC H04M 1/026

(57) ABSTRACT

Embodiments of the present disclosure provide a housing and an electronic device, wherein the housing is applicable to the electronic device and made of a metal material, including: a cover body and a border disposed along edges of the cover body; wherein the border is disposed with openings through which the electronic device transmits and/or receives a wireless signal. By disposing openings on the border of the metal housing of the electronic device, the metal housing can be prevented from shielding the wireless signal, and the user experience and the freedom degree of the design of the electronic device can be improved at the same time.

### CROSS-REFERENCE TO RELATED PATENT APPLICATION AND PRIORITY CLAIM

Priority is claimed from Chinese patent application No. 201410493414.2, filed Sep. 24, 2014, the entire disclosure of which hereby is incorporated by reference.

TECHNICAL FIELD

The present disclosure relates to the field of communications, and particularly, to a housing and an electronic device including the same.

### BACKGROUND

Currently, with the development of communication technologies, electronic devices, such as the mobile phone, tablet PC, etc., are widely used. In order to improve the durability of the electronic devices and the user experience, housings made of metal materials are increasingly employed in the electronic devices. But the metal materials shield the wireless signal transmission to a certain extent; thus, the housings made of metal materials will affect the transmission and reception of the wireless signal. The current solution is to open a slot or hole in the metal rear cover to permit the wireless signal transmission.

### SUMMARY

The existing method is to open a slot or hole in the rear cover of the metal housing. But this breaks the integrity of the rear cover, and affects the user experience and the freedom degree of the design of the electronic device.

Embodiments of the present disclosure provide a housing and an electronic device including the same. By disposing openings on the border of the metal housing of the electronic device, the metal housing can be prevented from shielding the wireless signal, and the user experience and the freedom degree of the design of the electronic device can be improved at the same time.

According to a first aspect of embodiments of the present disclosure, a housing is provided, which is applicable to an electronic device and made of a metal material, including a cover body and a border disposed along edges of the cover body; wherein the border is disposed with, e.g., includes, openings through which the electronic device transmits and/or receives a wireless signal.

According to a second aspect of embodiments of the present disclosure, an electronic device is provided, including a housing according to the first aspect of the embodiments of the present disclosure; and an antenna disposed inside the housing and configured to transmit and/or receive a wireless signal through openings on a border of the housing.

Embodiments of the present disclosure have the following beneficial effect: By disposing openings on the border of the metal housing of the electronic device, the metal housing can be prevented from shielding the wireless signal, and the user experience and the freedom degree of the design of the electronic device can be improved at the same time.

The following descriptions and drawings detailedly disclose embodiments of the present disclosure to indicate some ways for implementing principles of the present disclosure. It shall be appreciated that the range of the embodiments of the present disclosure is not limited thereto. Embodiments of the present disclosure include many changes, modifications and equivalents falling within the range of the spirit and clauses of the accompanied claims.

Feature information described and illustrated with respect to one embodiment can be used in one or more other embodiments in a same or similar way, can be combined with or can replace feature information in other embodiments.

To be emphasized, the term ‘include/include’ used herein specifies the presence of feature information, assembly, step or component, not excluding the presence or addition of one or more other feature information, assemblies, steps or components.

### BRIEF DESCRIPTION OF THE DRAWINGS

Many aspects of the present disclosure will be understood better with reference to the following drawings. The components in the drawings are not surely drafted in proportion; they are shown just for illustrating the principle of the present disclosure. For the convenience of illustrating and describing some portions of the present disclosure, corresponding portions in the drawings may be zoomed in or out. The elements and feature information illustrated in one drawing or embodiment of the present disclosure may be combined with the elements and feature information illustrated in one or more other drawings or embodiments. In addition, similar reference signs denote corresponding parts in several drawings, and can be used to denote corresponding parts in more than one embodiment.

In the drawings,

FIG. 1 is a structural diagram of a housing 100 in Embodiment 1 of the present disclosure;

FIG. 2 is another structural diagram of a housing 100 in Embodiment 1 of the present disclosure;

FIG. 3 is still another structural diagram of a housing 100 in Embodiment 1 of the present disclosure;

FIG. 4 is a structural diagram of an electronic device 400 in Embodiment 2 of the present disclosure;

FIG. 5 is a structural diagram of a mobile phone 500 in Embodiment 3 of the present disclosure; and

FIG. 6 is a structural diagram of an electronic device in Embodiment 4 of the present disclosure.

### DESCRIPTION OF THE EMBODIMENTS

The interchangeable terms ‘electronic device’ and ‘electronic apparatus’ include a portable radio communication device. The term ‘portable radio communication device’, which hereinafter may be referred to as ‘mobile radio terminal’, ‘portable electronic apparatus’, or ‘portable communication apparatus’, includes all devices such as mobile phone, pager, communication apparatus, electronic organizer, personal digital assistant (PDA), smart phone, portable communication apparatus, etc.

In the present application, the embodiments of the present disclosure are mainly described with respect to a portable electronic apparatus in the form of a mobile phone (also referred to as ‘cellular phone’). However, it shall be appreciated that the present disclosure is not limited to the case of the mobile phone and it may relate to any type of appropriate electronic device, such as photo camera, video camera, tablet PC, smart watch, smart glasses, head-mounted device, wearable device, fixed-line telephone, media player, gaming device, PDA and computer, etc.

The preferred embodiments of the present disclosure are described as follows with reference to the drawings.

### Embodiment 1

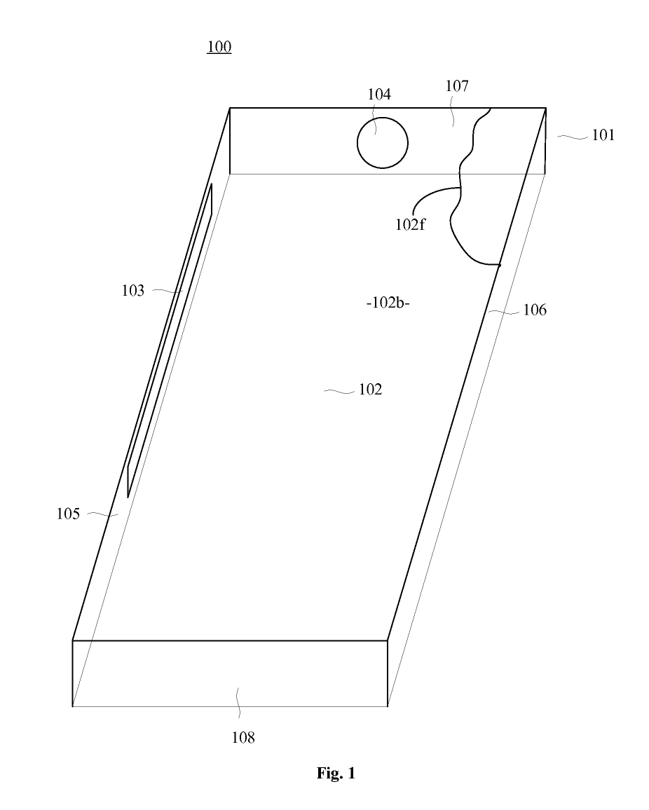

An embodiment of the present disclosure provides a housing applicable to an electronic device. FIG. 1 is a structural diagram of a housing 100 in Embodiment 1 of the present disclosure. As illustrated in FIG. 1, the housing 100 is made of a metal material, including a border 101 and a cover body 102. The border 101 is disposed along edges of the cover body 102; and the border 101 is disposed with, e.g., includes, openings 103 and 104 through which the electronic device transmits and/or receives the wireless signal.

As can be seen from the above embodiment, by disposing openings on the border of the metal housing of the electronic device, the metal housing can be prevented from shielding the wireless signal, e.g., shielding or blocking of the wireless signal is avoided, and the user experience and the freedom degree of the design of the electronic device can be improved at the same time.

Thus, it will be appreciated that the border 101 has at least one opening, such as, for example a slot 103, hole 104 or other shape or configuration opening, through which the electronic device transmits and/or receives a wireless signal (also referred to as wireless communication signal). There may be more than one such opening, e.g., a plurality of openings or a number of openings. Moreover, such opening(s) are in proximity to, e.g., relatively near, one or more respective antennas of the electronic device to provide for such transmitting and/or receiving of a wireless signal with respect to such antenna(s). The front 102f and back 102b of the cover body 102, e.g., the front and back of the electronic device, may have one or more other openings, for example, to contain parts, such as the camera lens, and so on. Such opening(s) in the front face and back face of the cover body 102 would not likely be near an antenna, and, therefore, would not need to serve as an unimpeded path for the wireless communication signal. Accordingly, any openings that are in the front or back are not sufficiently near an antenna of the electronic device for primarily transmitting or receiving a wireless signals for communication by the electronic device.

In this embodiment, the shape of the housing 100 can be determined upon the actual demand. In this embodiment the housing 100 may have a regular shape. For example, when the electronic device is a mobile phone, the housing may be a cuboid with a small thickness or it has a shape similar thereto. The housing 100 may also have an irregular or bent shape. Correspondingly, the antenna structure of the electronic device may be designed adaptively according to the shape of the housing. Thus, the housing may be applied to a smart watch or other wearable device. The above descriptions are just exemplary, and the shape of the housing is not limited herein.

In this embodiment, the metal material of the housing 100 may be determined upon the actual demand. For example, materials such as stainless steel, aluminum alloy, magnesium alloy and titanium alloy may be used. The material of the housing is not limited herein.

In this embodiment, the border 101 is disposed along edges of the cover body 102. For example, as is illustrated, wherein the border 101 may be disposed along one or more edges of the cover body 102, which is not limited herein.

FIG. 1 exemplarily illustrates a situation where the border 101 is disposed along all the edges of the cover body 102. As illustrated in FIG. 1, when the border 101 is disposed along all the edges of the cover body 102, the border 101 may include a left side portion 105, a right side portion 106, an upper end portion 107 and a lower end portion 108.

In this embodiment, the upper, lower, left and right directions may be determined upon the use state of the electronic device. For example, when the electronic device is a mobile phone, the directions are determined upon the use state of the user-hand-held mobile phone.

In this embodiment, the sizes of the border 101 and the cover body 102 may be determined upon the actual demand. For example, the sizes of the border 101 and the cover body 102 in the housing 100 may be determined upon the design requirement of the electronic device.

In this embodiment, the border 101 and the cover body 102 may be made separately and then connected to each other. For example, the border 101 and the cover body 102 may be connected to each other through engagement, welding, bonding, etc.

In this embodiment, the border 101 and the cover body 102 may also be formed integrally. For example, the border 101 and the cover body 102 may be formed in an integrated method such as stamping, die casting, etc.

In this embodiment, the form of the opening may be determined upon the actual demand. For example, the opening may include a slot and/or a hole. FIG. 1 exemplarily illustrates a situation where the opening includes a slot 103 and a hole 104. In addition, a slot 103 or a hole 104 may also be disposed separately. The form of the opening is not limited herein.

In this embodiment, the slot 103 and/or the hole 104 may be disposed throughout the thickness direction of the border 101. The method for forming the slot or the hole may be determined upon the actual demand. For example, the slot or the hole may be formed through cutting, stamping, etc.

In this embodiment, the positions of the slot 103 and/or the hole 104 may be determined upon the actual demand, without being limited herein. For example, the slot 103 and/or the hole 104 may be disposed on at least one of the left side portion 105; the right side portion 106 and the upper end portion 107. For example, as illustrated in FIG. 1, the slot 103 is disposed on the left side portion 105, the hole 104 is disposed on the upper end portion 107; and the slot 103 and the hole 104 are disposed at the middle positions in the width directions of the left side portion 105 and the upper end portion 107, respectively.

In this embodiment, the slot 103 may be formed continuously on the left side portion 105, the upper end portion 107 and the right side portion 106. The number of the slot 103 may be one or more. When the number is more than one, the slots 103 may be continuously arranged along the length directions of the left side portion 105, the upper end portion 107 and the right side portion 106. When the number is one, the slot 103 is continuous throughout the length directions of the left side portion 105, the upper end portion 107 and the right side portion 106.

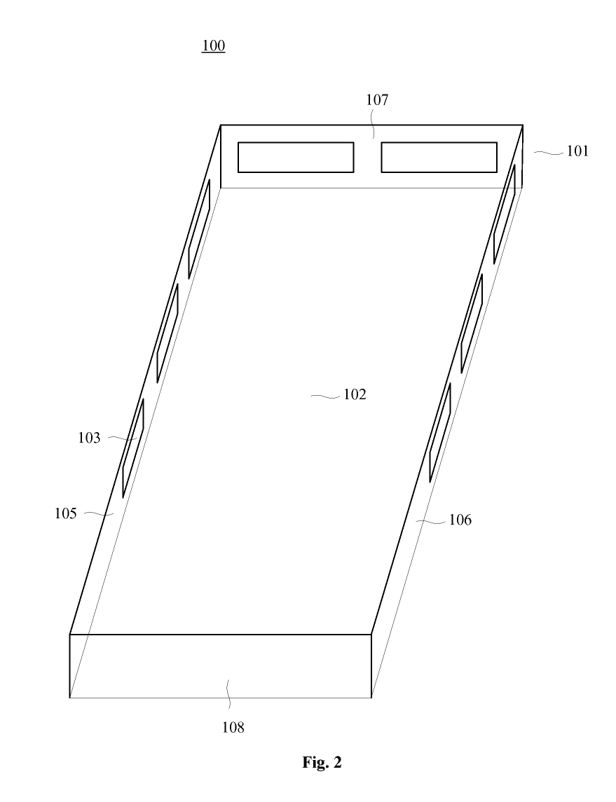

FIG. 2 is another structural diagram of a housing 100 in Embodiment 1 of the present disclosure. As illustrated in FIG. 2, the border 101 of the housing has no hole, and a plurality of elongated slots 103 are continuously disposed along the length directions of the left side portion 105, the upper end portion 107 and the right side portion 106.

In this embodiment, the openings on the border may also be designed in the form of a plurality of continuous holes, or a plurality of continuous slots and holes. The form and order of the continuous openings, and the distance between the slots and holes are not limited herein.

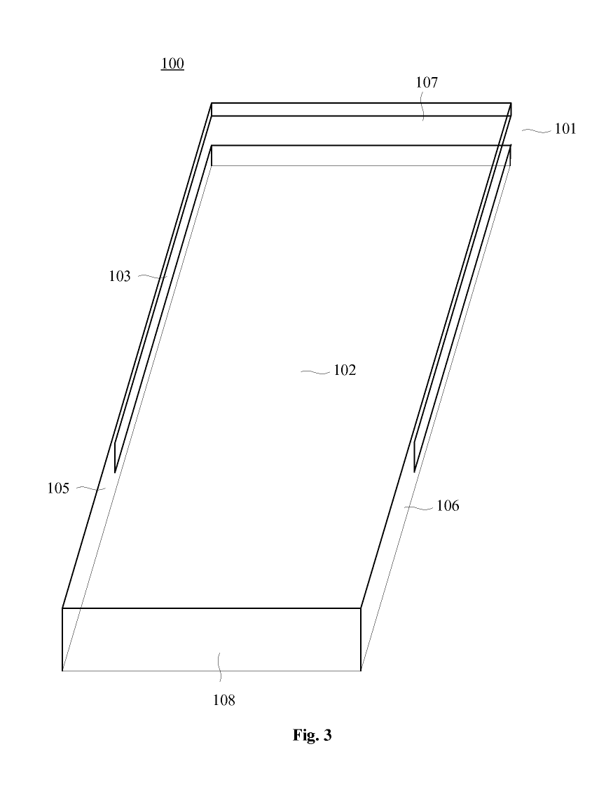

FIG. 3 is still another structural diagram of a housing 100 in Embodiment 1 of the present disclosure. As illustrated in FIG. 3, the border 101 of the housing has no hole, and an elongated slot 103 is continuous throughout the length directions of the left side portion 105, the upper end portion 107 and the right side portion 106.

In this embodiment, other structures in FIGS. 2-3 are the same as those in FIG. 1, and herein are not repeated.

In this embodiment, the openings 103 and 104 may be set to be adjacent to the antenna of the electronic device, so as to further prevent the metal housing from shielding the wireless signal, and improve the performance of the electronic device to transmit and/or receive the wireless signal.

For example, the distance from the openings 103 and 104 to the antenna of the electronic device may be from about 0.5 mm to about 5 mm. The distance from the openings 103 and 104 to the antenna of the electronic device is not limited herein.

In this embodiment, the numbers of the slots 103 and/or the holes 104 may be set upon the actual demand, and are not limited herein. For example, corresponding number of slots or holes may be disposed according to the number of antennas in the electronic device. Alternatively, a single long slot may also be disposed, through which a plurality of antennas transmit and/or receive the wireless signal.

In this embodiment, the shape of the respective slot 103 or the hole 104 may be set upon the actual demand, wherein the slot 103 or the hole 104 may have a regular shape, such as the elongated slot 103 and the circular hole 104 illustrated in FIG. 1; and/or a slot 103 or a hole 104 may also have an irregular shape. The shape of the slot 103 or the hole 104 is not limited herein.

In this embodiment, the size of the slot 103 or the hole 104 may be determined upon the actual demand and the size of the border 101. For example, in order to improve the passability of the wireless signal, the size of the slot(s) 103 or the hole(s) 104 shall be increased so far as possible. However, since the slot 103 or the hole 104 is disposed on the border 101, the size of the slot 103 or the hole 104 is limited by the size of the border 101.

For example, as illustrated in FIG. 1, the left side portion and the right side portion have the same size, e.g., a length of about 130 mm and a width of about 8 mm The upper end portion and the lower end portion have the same size, e.g., a length of about 60 mm and a width of about 8 mm The elongated slot 103 has a length of about 70 mm and a width of about 6 mm. The slot 103 has a distance of about 50 mm to the bottom of the left side portion 105, and a distance of about 10 mm to the top of the left side portion 105. The slot 103 is disposed at a middle position in the width direction of the left side portion 105. The hole 104 has a diameter of about 7 mm, and it is disposed at middle position in the length and width directions of the upper end portion 107, respectively. The sizes of the border 101 and the slot 103 or the hole 104 thereon are just exemplarily described, rather than being limited herein.

As can be seen from the above embodiment, by disposing openings on the border of the metal housing of the electronic device, the metal housing can be prevented from shielding the wireless signal, and the user experience and the freedom degree of the design of the electronic device can be improved at the same time.

### Embodiment 2

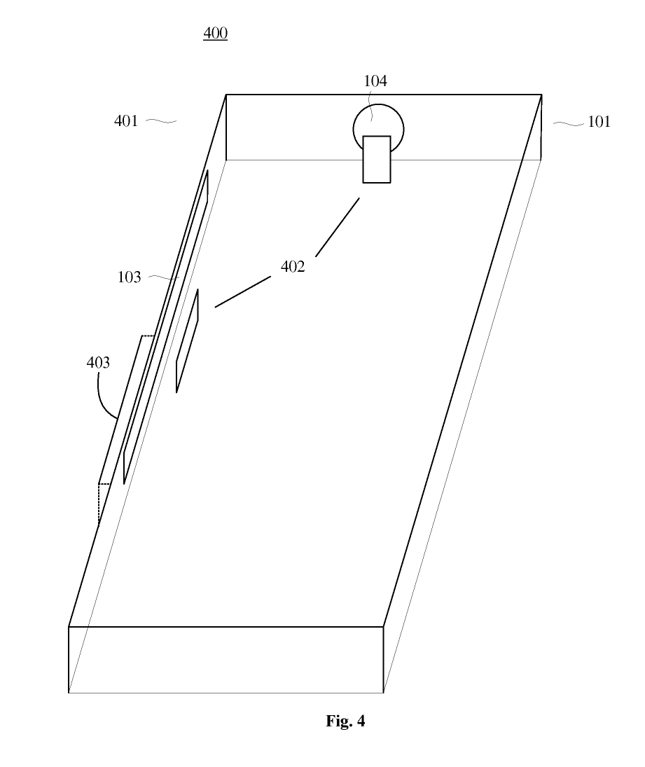

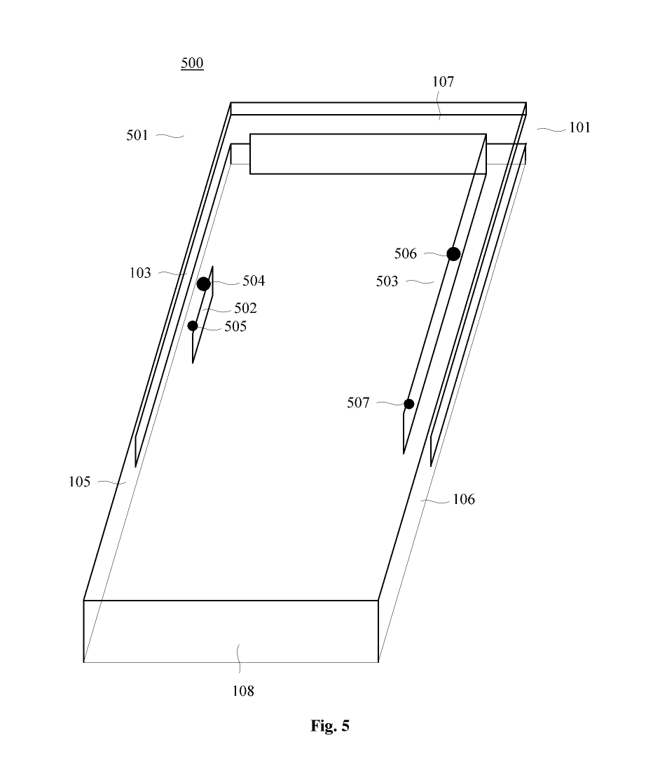

This embodiment of the present disclosure provides an electronic device. FIG. 4 is a structural diagram of an electronic device 400 in Embodiment 2 of the present disclosure. As illustrated in FIG. 4, the electronic device 400 includes a housing 401 and an antenna 402. In this exemplary embodiment the housing 401 has the same structure and material as the housing 100 in Embodiment 1, and it is not repeatedly described herein. Also, the antenna 402 is disposed inside the housing 401 to transmit and/or receive a wireless signal 402 through openings 103 and 104 on a border 101 of the housing 401. Other parts of the electronic device are not illustrated in this FIG. 4 but may be, for example, as shown in FIGS. 5 and/or 6.

As can be seen from the above embodiment, by disposing openings on the border of the metal housing of the electronic device, the metal housing can be prevented from shielding the wireless signal, and the user experience and the freedom degree of the design of the electronic device can be improved at the same time.

In this embodiment, the position of the antenna 402 may be determined upon the actual demand.

In this embodiment, the antenna 402 may be disposed to be adjacent to the openings 103 and 104, so as to further prevent the metal housing from shielding the wireless signal, and improve the performance of the electronic device to transmit and/or receive the wireless signal.

For example, the distance from the antenna 402 to the openings 103 and 104 is from about 0.5 mm to about 5 mm, which is not limited herein.

In this embodiment, the antenna 402 may be disposed along the openings 103 and 104 on the border 101 of the housing 401, so as to further improve the performance of the electronic device to transmit and/or receive the wireless signal.

In this embodiment, the antenna 402 may be perpendicularly mounted on the top of the ground plane, so that the antenna 402 is disposed in parallel with the openings 103 and 104, thereby further improving the performance of the electronic device to transmit and/or receive the wireless signal.

In this embodiment, the number and type of the antenna 402 may be set upon the actual demand. For example, the antenna 402 may include at least one of main Long Term Evolution (LTE) antenna, auxiliary LTE antenna, Bluetooth antenna, WIFI antenna and Global Positioning System (GPS) antenna. The WIFI antenna and the GPS antenna may be integrated into one antenna. The number and type of the antenna(s) are not limited herein.

In this embodiment, the parameters of the antenna 402 may be set upon the actual demand, and they are not limited herein. For example, the parameters of the antenna 402 may be set according to the requirements of different communication networks.

In this embodiment, the shape of the antenna 402 may be set upon the actual demand, and it is not limited herein. For example, the antenna 402 may be designed to be elongated and adaptive or adapted to the shape of the elongated slot 103.

In this embodiment, the shape of the antenna 402 may be adaptive or adapted to the shape of the housing 401. For example, when the electronic device 400 is a smart watch or other wearable device, the housing 401 may have a curved surface, and the shape of the antenna 402 may be designed to be adaptive to the shape of the curved surface.

In this embodiment, the electronic device 400 may further include a non-metal layer 403 which covers the openings 103 and 104 on the border 101 of the housing 401. In FIG. 4 a representative portion of such non-metal layer 403 is shown in fragmentary form, as is represented by some broken lines, but it will be appreciated that the non-metal layer may extend on or over part or all of the housing, as is described elsewhere herein.

By covering the non-metal layer on the openings, impurities such as dusts and moistures are prevented from entering the inside of the electronic device through the slots and the holes, thereby improving the durability of the cellular phone, the appearance quality of the product, and the user experience.

In this embodiment, the non-metal layer 403 may cover the entire border 101, thereby covering the openings 103 and 104 formed on the border 101, so as to increase the integrity of the border, and further improve the user experience. In one implementation, the non-metal layer 403 may be a membrane covering the whole outer surface of the housing 401, thereby also covering the openings 103 and 104 formed on the border 101 of the housing 401.

In this embodiment, the material of the non-metal layer may be determined upon the actual demand. For example, the non-metal layer may be made of any of glass, plastics, resin and rubber.

In this embodiment, in addition to being used by the antenna of the electronic device to transmit and/or receive the wireless signal therethrough, the openings on the border may also be disposed with an interface of the electronic device and functional keys. For example, parts of the openings beyond the position corresponding to the antenna may be disposed with one or more of a USB interface, a headset jack, a volume key and a shooting key, (to shoot pictures, e.g., a shutter release). Other usages of the openings are not limited herein.

As can be seen from the above embodiment, by disposing openings on the border of the metal housing of the electronic device, the metal housing can be prevented from shielding the wireless signal, and the user experience and the freedom degree of the design of the electronic device can be improved at the same time.

### Embodiment 3

This embodiment of the present disclosure exemplarily represents and is illustrative of an electronic device by taking a ‘mobile phone’ as an example. FIG. 5 is a structural diagram of a mobile phone 500 in Embodiment 3 of the present disclosure. As illustrated in FIG. 5, the mobile phone 500 includes a housing 501, a first antenna 502 and a second antenna 503, wherein, the housing 501 has the same structure and material as the housing 100 in Embodiment 1, and it is not repeatedly described herein.

This embodiment gives exemplary descriptions by taking the structure in FIG. 3 as an example, where one elongated slot 103 is continuous throughout the length directions of the left side portion 105, the upper end portion 107 and the right side portion 106.

The first antenna 502 and the second antenna 503 are disposed inside the housing 501 along the elongated slot 103 respectively. The first antenna 502 and the second antenna 503 transmit and/or receive the wireless signal through the elongated slot 103.

In this embodiment, the types of the first antenna 502 and the second antenna 503 may be set upon the actual demand. For example, the first antenna 502 may be an integrated GPS/WIFI antenna, which serves as a GPS antenna and a WIFI antenna at the same time, and the second antenna 503 may be an auxiliary LTE antenna. The mobile phone 500 may further include a Bluetooth antenna and a main LTE antenna, which are not illustrated in FIG. 5.

In this embodiment, the shapes of the first antenna 502 and the second antenna 503 may be set upon the actual demand. For example, the first antenna 502 may be designed as a patch (sometimes referred to as a patch antenna, e.g., a microstrip antenna pasted on) with a regular shape, and the second antenna 503 may be designed as a patch (or patch antenna) with an irregular shape. The shapes of the antennas are not limited herein.

In this embodiment, the first antenna 502 includes a feed point 504 and a ground point 505, and the second antenna 503 includes a feed point 506 and a ground point 507, wherein the numbers and positions of the feed point 504, the ground point 505, the feed point 506 and the ground point 507 may be determined upon the actual demand. The numbers and positions of the feed points and the ground points are not limited herein.

As can be seen from the above embodiment, by disposing openings on the border of the metal housing of the electronic device, the metal housing can be prevented from shielding the wireless signal, and the user experience and the freedom degree of the design of the electronic device can be improved at the same time.

### Embodiment 4

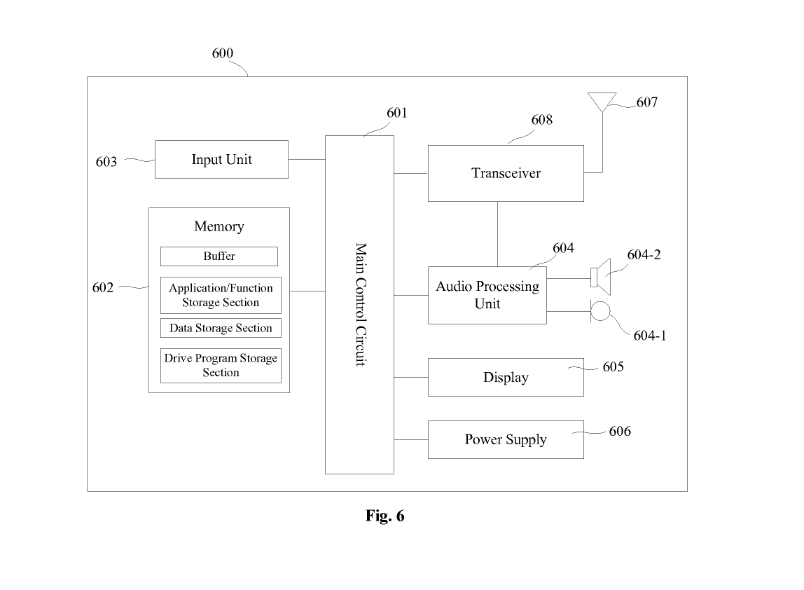

FIG. 6 is a structural diagram of an electronic device in Embodiment 4 of the present disclosure. The electronic device is for example a mobile phone, and FIG. 6 is just exemplary. The mobile phone 600 may further include the circuit parts of other types to supplement or replace the operation circuit, so as to realize the communication function or other function. Obviously, the mobile phone 600 does not necessarily include all the parts illustrated in FIG. 6.

As illustrated in FIG. 6, the mobile phone 600 includes a main control circuit 601, a transceiver 608, an input unit 603, an audio processing unit 604, a microphone 604-1, a speaker 604-2, a memory 602, a display 605, a power supply 606 and an antenna 607 The mobile phone 600 further includes a housing (not illustrated) described in Embodiment 1, and the antenna 607 transmits and/or receives the wireless signal along or via or through the slot on the border of the housing.

The main control circuit 601 sometimes is called as controller or operation control, and it may include a microprocessor or other processor device and/or logic device. The main control circuit 601 receives an input and controls the operations on respective parts of the mobile phone 600.

The memory 602 for example may be one or more of buffer, flash memory, hard drive, removable media, volatile memory, nonvolatile memory or other appropriate device. The memory 602 may store a program to be executed to carry out functions of the mobile phone 600. In addition, the main control circuit 601 may execute the program stored in the memory. The functions of other parts are similar to those of the prior art, and herein are omitted.

The parts of the mobile phone 600 may be implemented with special hardware, firmware, software or combinations thereof, without deviating from the scope of the present disclosure.

As can be seen from the above embodiment, by disposing openings on the border of the metal housing of the electronic device, the metal housing can be prevented from shielding the wireless signal, and the user experience and the freedom degree of the design of the electronic device can be improved at the same time.

The above apparatus and method of the present disclosure may be implemented by hardware, or a combination of hardware and software. The present disclosure relates to such a computer readable program that enables a logic part to implement the previously described apparatuses or constituent parts, or implement the previously described methods or steps, when the program is executed by the logic part.

The present disclosure also relates to a storage medium for storing the above program, e.g., hard disk, magnetic disk, optical disk, DVD and flash memory.

The present disclosure is described in conjunction with the above embodiments. But a person skilled in the art shall appreciate that the descriptions are just exemplary, rather than limitations to the protection scope of the present disclosure. A person skilled in the art can make various modifications and changes to the present disclosure under the spirit and principle of the present disclosure, and those modifications and changes also fall within the scope of the present disclosure.

1. A housing, being applicable to an electronic device and made of a metal material, comprising a cover body and a border disposed along edges of the cover body; wherein,
the border is disposed with at least one opening through which the electronic device transmits and/or receives a wireless signal.

2. The housing according to claim 1, wherein the at least one opening is adjacent to an antenna of the electronic device.

3. The housing according to claim 1, wherein the border comprises an upper end portion, a lower end portion, a left side portion and a right side portion, and the at least one opening is disposed on at least one of the left side portion, the right side portion and the upper end portion of the border.

4. The housing according to claim 3, wherein the at least one opening comprises a number of openings that are continuously formed on the left side portion, the right side portion and the upper end portion of the border.

5. The housing according to claim 3, wherein the at least one opening comprises one opening that is continuously formed along the length directions of at least part of the left side portion, upper end portion and right side portion of the border.

6. The housing according to claim 1, wherein the one or more openings comprise one or more slots and/or one or more holes.

7. An electronic device, comprising:
a housing according to claim 6,
an antenna disposed inside the housing and configured to transmit and/or receive a wireless signal through at least one of the openings on a border of the housing.

8. The electronic device according to claim 7, wherein the antenna is disposed along the openings on the border.

9. The electronic device according to claim 7, wherein the antenna is disposed in parallel with the openings on the border.

10. The electronic device according to claim 7, wherein the antenna comprises at least one of main LTE antenna, auxiliary LTEantenna, Bluetooth antenna, WIFI antenna and GPS antenna.

11. The electronic device according to claim 7, wherein a distance from the antenna to the openings on the border is from about 0.5 mm to about 5 mm.

12. The electronic device according to claim 7, further comprising:
a non-metal layer which covers the at least one of the one or more openings on the border of the housing.

13. The electronic device according to claim 12, wherein the non-metal layer covers at least part of the housing in addition to the one or more openings on the border of the housing.

14. The electronic device according to claim 7, wherein the cover body includes a front and back and any openings in the front or back are not sufficiently near an antenna of the electronic device for primarily transmitting or receiving a wireless signals for communication by the electronic device.

15. The electronic device according to claim 8, wherein the cover body includes a front and back and any openings in the front or back are not sufficiently near an antenna of the electronic device for primarily transmitting or receiving a wireless signals for communication by the electronic device.

16. The electronic device according to claim 11, wherein the cover body includes a front and back and any openings in the front or back are not sufficiently near an antenna of the electronic device for primarily transmitting or receiving a wireless signals for communication by the electronic device.

17. The electronic device according to claim 12, wherein the cover body includes a front and back and any openings in the front or back are not sufficiently near an antenna of the electronic device for primarily transmitting or receiving a wireless signals for communication by the electronic device.

18. An electronic device, comprising:
a housing according to claim 2;
an antenna disposed inside the housing and configured to transmit and/or receive a wireless signal through at least one of the openings on a border of the housing.

19. An electronic device, comprising:
a housing according to claim 3;
an antenna disposed inside the housing and configured to transmit and/or receive a wireless signal through at least one of the openings on a border of the housing.

20. An electronic device, comprising:
a housing according to claim 6;
an antenna disposed inside the housing and configured to transmit and/or receive a wireless signal through at least one of the openings on a border of the housing.
